(19) United States
(12) Patent Application Publication
(10) Pub. No.: US 2024/0081384 A1
(43) Pub. Date: Mar. 14, 2024

(54) A CONTINUOUS PROCESS BASED RADIANT HEAT DRYER SYSTEM

(71) Applicant: SRINATH GUDDANAHALLI SREENIVAS, Bangalore (IN)

(72) Inventor: SRINATH GUDDANAHALLI SREENIVAS, Bangalore (IN)

(21) Appl. No.: 17/768,090

(22) PCT Filed: Oct. 13, 2020
(86) PCT No.: PCT/IB2020/059605

§ 371 Date: Apr. 11, 2022

(30) Foreign Application Priority Data
Oct. 13, 2019 (IN) 201941024667
Feb. 5, 2020 (IN) 202041005001
Jun. 25, 2020 (IN) 202041027084

(51) Int. Cl. A23N 12/08; F26B 3/28; F26B 3/30; F26B 17/04; F26B 25/22

(52) U.S. Cl. CPC A23N 12/08; F26B 3/283; F26B 3/30; F26B 17/04; F26B 25/22; F26B 2200/06

(57) ABSTRACT

A drying system (100) for agricultural produce (5) is disclosed, comprising heat emitting sources (3), placed over a continuous moving grain bed with uniform thickness and with a consistent PEG, so that the heat imparted are uniform over the agricultural produce (5) at any given passage point. The system (100) comprises conveyor belts (9), having passes (10) and each pass (10) is adapted to transit the agricultural produce. Heat emitting sources (3) are placed above each pass (10) of the conveyor belt (9), and the heat emitting source (3) is adapted to radiate heat onto the agricultural produce. The heat emitting sources (3) are strategically placed at uniform height over a flowing bed of agricultural produce (5) with controlled thickness to have a preset Produce to Emitter Gap (PEG), and are charged in controlled way to emit pre-determined intensity of radiation or pre-determined temperature setting to be imparted on the agricultural produce (5).

### FIELD OF THE INVENTION

The present invention relates generally to the field of agricultural equipment. More specifically, the invention relates to the field of driers used for drying of various agriculture produce.

### BACKGROUND OF THE INVENTION

Agriculture produce drying mechanism is the process of drying agriculture produces to prevent spoilage during storage. There are various existing techniques in prior art that are used for agriculture produce drying. One such technique of drying involves drying under sunlight over a vast patch of prepared land. This technique involves a labor-intensive process utilizing either manual or semi-mechanized means to spread out and subsequently gather back the agriculture produce to and from the open-air drying areas. This is particularly stressful to the workers especially in adverse weather conditions normally found during drying seasons.

Another common method of drying uses steam driers and or heat pump method wherein steam is generated in boilers by burning wood, husk or any other combustible fuel and the heat of the steam is used to heat the agricultural produce by conduction or convection methods over long period of time to achieve the requisite drying results.

Another known process is a natural open-air drying process, where the produce to be dried is spread out on a vast land and allowed to dry under action of natural elements which has its disadvantages of long drying times and uncertainties in rainy seasons, poor process control etc.

Grain drying process is accomplished to prevent spoilage of agricultural grains during their storage. Grains such as wheat, corn, soybean, rice and other grains as sorghum, sunflower seeds, rapeseed, barley, oats seeds are dried in grain dryers in hundreds of millions of tons. A grain drying equipment uses fuel- or electric-powered source for functioning. Aeration, unheated or natural grain drying, deration, in-storage cooling, heated air grain drying, solar drying, etc. are some of the conventional methods adapted for drying of grains.

The conventionally used driers have a lot of disadvantages like poor process control, inefficient energy transfer methods, environmental issues related to burning of fuels, larger drying times, rigid processes, non-flexible equipment in terms of type of applicable produce etc. and comes with a lot of process rejects due to poor handling abilities.

Therefore, there is a need for an efficient and formidable system for drying agricultural grains, fruits, seeds, vegetables, etc. as per preset optimum drying curves.

### OBJECT OF THE INVENTION

The object of the invention is to provide a compact and efficient drying mechanism for drying various agriculture produce at industrial volume scales

### SUMMARY OF THE INVENTION

The shortcomings of the prior art are overcome, and additional advantages are provided through the provision of the present disclosure. Additional features and advantages are realized through the techniques of the present disclosure. Other embodiments and aspects of the disclosure are described in detail herein and are considered a part of the disclosure.

The present disclosure discloses a drying system for grains for drying agricultural produce. The system comprises conveyor belts, having one or more pass and each of the pass is adapted to transit the agricultural produce. The system further comprises heat emitting sources placed above each pass of the conveyor belt, and the heat emitting source is adapted to radiate heat onto the agricultural produce. The heat emitting sources are a series of Infrared heaters (IR heaters), which are strategically placed at uniform height over a flowing bed of grains with controlled thickness to have a preset Produce to Emitter Gap (PEG). The Heat emitting sources are charged in a controlled way to emit a pre-determined intensity of radiation or a pre-determined temperature setting to be imparted on the grains. A PEG gap maintenance means is provided, which is adapted to maintain a predefined gap between the agricultural produce and the heat emitting source. A heat controller is provided to control the one or more heat emitting source by either controlling intensity of the radiation or temperature of the heat emitting source.

These agricultural produces would get heated as it flows below the Heat emitting sources to emulate any drying curve as desired by simply setting the IR heating parameters for the desired energy levels or temperatures. By employing sensors and PLC controls, the entire sequence can be automated. Also, the time vs heat curve can be achieved by arranging the grain flow length and heating cycles to be long enough to match the desired drying curves intended for that particular type of produce to be dried.

The system comprises sensors, such as temperature sensors, moisture sensors, or both. the temperature sensors are adapted to sense at least a temperature of the agricultural produce or the heat controller or combination thereof. The temperature sensors are adapted to generate a temperature data, and the moisture sensors are adapted to sense at least moisture of the agricultural produce or an environment in which is agricultural produce is to be transited or in transit, or combination thereof, and adapted to generate a moisture data. A microprocessor is provided, which is adapted to receive and process at least the temperature data, the moisture data, or combination thereof, along with a predefined set of rules, and to generate a change trigger. The heat controller is adapted to receive and process the change trigger and adapted to control the one or more heat emitting source based on such processing.

The one or more passes of the conveyor belts are divided into more than one heat zones, and each heat zone has at least one or more temperature sensors to generate the temperature data for it, and one or more moisture sensors to generate the moisture data for each heat zone, or combination thereof. The microprocessor is adapted to process at least one of the temperature data for each heat zones, the moisture data of each of the heat zones, or combination thereof. The microprocessor thereafter generates change triggers of each of the heat zones, and the heat controller is adapted to receive and process each of the change triggers and adapted to control the one or more heat emitting source based on such processing.

The system comprises mixing means, adapted to mix the agricultural produce while the agricultural produce is in transit. The mixing means are placed along the length of the one or more pass through which the agricultural produce is adapted to be transited. Further, the mixing means are placed at a predefined distance which is more than the predefined gap between the agricultural produce and the heat emitting source. The system comprises various categories of mixing means, and each category of the mixing rods are placed at different predefined distances. The mixing means are placed at predefined intervals along the pass of the conveyor belt. With a mixing arrangement of grains, it can be ensured that the heating of the grains is more consistent across the various depths of the grain in the grain bed and the desired drying curve is effective enough to achieve an even process on all grains under process.

The system comprises radiation reflectors, functionally coupled to the Heat emitting sources, and to reflect the radiations towards the pass which is adapted to transit the agricultural produce for drying. The radiation reflectors are placed either above the Heat emitting sources, or onto one of sides non-parallel to a surface of the conveyor belt, or combination thereof.

The PEG gap maintenance means comprises a leveler rod, which is placed at a leveler distance from the Heat emitting source which is equivalent to the predefined gap. The PEG gap maintenance means further comprises a hopper placed on a path of inlet of the agricultural produce to a first pass of the system, and is placed at a hop distance from the first pass of the conveyor belt. This is required to provide a height of the agricultural produce bed onto the conveyor belt so as to achieve the predefined gap from the heat emitting source.

An aeration means is provided between passes of the one or more conveyor belts, which is adapted to pass the air around and/or through the agricultural produce when the agricultural produce is in transit.

It is to be understood that the aspects and embodiments of the disclosure described above may be used in any combination with each other. Several of the aspects and embodiments may be combined together to form a further embodiment of the disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

The novel features and characteristics of the disclosure are set forth in the description. The disclosure itself, however, as well as a preferred mode of use, further objectives and advantages thereof, will best be understood by reference to the following description of an illustrative embodiment when read in conjunction with the accompanying drawings. One or more embodiments are now described, by way of example only, with reference to the accompanying drawings wherein like reference numerals represent like elements and in which:

FIG. 1 represents a schematic diagram showing the general arrangement of the grain bed, the positioning of the Heat emitting sources and the consistent PEG gap arrangement as the grain moves in a continuous flow, in accordance with the embodiments of the present disclosure.

FIG. 2 represents a schematic diagram depicting the IR heating arrangement over a lengthier pass setup of the grain flow, in accordance with the embodiments of the present disclosure.

FIG. 3 represents a schematic diagram depicting the mixing means deployed intermittently along the grain flow path for consistent heat disbursal among grains, in accordance with the embodiments of the present disclosure.

FIG. 4 represents a schematic diagram depicting the various depths of the grain bed that can be employed for the drying process and the various mixing means deployment options to attain a consistent drying effect at varied grain bed depths thereof, in accordance with the embodiments of the present disclosure.

FIG. 5 represents a schematic diagram depicting the simulation of a drying curve over the grain flow along the flow length of the grains, in accordance with the embodiments of the present disclosure.

FIG. 6 represents a schematic diagram of the adaptation of the drying curve concept over a multi pass drying process of the grains in a continuous flow arrangement, in accordance with the embodiments of the present disclosure.

FIG. 7 depicts a visual representation of Temperature Gradient along the Grain flow path in line with the preset drying curves, in accordance with the embodiments of the present disclosure.

FIG. 8 represents a process flow diagram, depicting the automated control loop for temperature and moisture controls of the grain and heat emitting source using contact sensors, in accordance with the embodiments of the present disclosure.

FIG. 9 represents the Grain bed leveling method used for obtaining a uniform PEG for a controlled IR heating, in accordance with the embodiments of the present disclosure.

FIG. 10 represents a schematic diagram of the Heat emitting sources positioned over the grain bed and the use of Radiation reflectors used to improve the efficiency of the heat transfer by redirecting the outward-bound radiant energy on to the below grain bed, in accordance with the embodiments of the present disclosure.

The figures depict embodiments of the disclosure for purposes of illustration only. One skilled in the art will readily recognize from the following description that alternative embodiments of the assemblies, structures and methods illustrated herein may be employed without departing from the principles of the disclosure described herein.

### DETAILED DESCRIPTION

For the purpose of promoting an understanding of the principles of the invention, reference will now be made to the embodiment illustrated in the figures and specific language will be used to describe them. It will nevertheless be understood that no limitation of the scope of the invention is thereby intended. Such alterations and further modifications in the illustrated system, and such further applications of the principles of the invention as would normally occur to those skilled in the art are to be construed as being within the scope of the present invention.

It will be understood by those skilled in the art that the foregoing general description and the following detailed description are exemplary and explanatory of the invention and are not intended to be restrictive thereof.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more sub-systems or elements or structures or components preceded by “comprises . . . a” does not, without more constraints, preclude the existence of other, sub-systems, elements, structures, components, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this invention belongs. The system, methods, and examples provided herein are only illustrative and not intended to be limiting.

Embodiments of the present invention will be described below in detail with reference to the accompanying figures.

The system, methods, and examples provided herein are only illustrative and not intended to be limiting.

Cereal grains and legumes are mostly harvested at moisture contents too high for conservative storage. Thus, drying them becomes an essential process before storing them. A large amount of water has to be removed in drying wet grains. Hence, adequate amount of drying air has to be provided to the grains to assure that drying to safe-storage moisture contents is completed before microbial deterioration of the grain initiates. This is the main objective of all sun and mechanical grain drying based systems.

The largest dryers are in plants and are of the continuous type such as mixed-flow dryers and Cross-flow dryers. Continuous flow dryers may result up to 100 metric tons of dried grain per hour. They generally consist of a bin, with heated air flowing horizontally from an internal cylinder through an inner perforated metal sheet, then through an annular grain bed in radial direction, and finally across the outer perforated metal sheet, before being discharged to the atmosphere. The usual drying times depends on how much water must be removed, type of grain, air temperature and the grain depth.

The present disclosure provides a compact and efficient drying mechanism for drying various agriculture produce at industrial volume scales with the intent of application of any preset drying rate curve with direct heat transfer method via radiant energy method using Infrared radiation heating systems. This would provide an efficient and controlled drying of raw, semi-processed and/or processed agricultural produce including paddy, corns, grains, lintels and the like, on a sustainable basis, utilizing the minimum possible area. The direct heat transfer would therefore eliminate the low generation losses of fossil fuels or flammable fuels, transmission losses, equipment losses and inefficient heat transfers to the grains ultimately which normally has breakages and other quality issues.

By virtue of direct heating of the produce by radiant energy, the energy transfer efficiency of above 95% can be achieved. And with a closed loop control system, the heating process can be controlled through the entire heat cycle very accurately to limit the total variation to less than 1 deg. Celsius.

It may be noted that even though a lot of research has been made till date from as early as 1980s onwards on the usefulness, suitability, benefits of IR heating methods over conventional methods for grain drying processes and other food process related applications, all the studies and efforts have so far been limited to small scale batch volumes while an effective industrialization of this technology hasn't been made as is evident in the grain processing industry today, all over the world. This is basically because of the lack of a suitable equipment that could adopt this IR heating technology for a holistic lasting solution.

This invention is therefore is an effort to overcome all such limitations and hurdles to effectively devise a way of utilizing this highly efficient IR heating technology in a way to use it to accurately heat the agriculture produce to a precise predetermined drying cycle with automatic controls and more importantly on a continuous process basis and for large volumes with consistency and sustainability. The system and method are also capable for providing dehydration process for the various fruits, vegetables, seeds and the like and drying any organic & inorganic products, by virtue of its unique versatility and process flexibility.

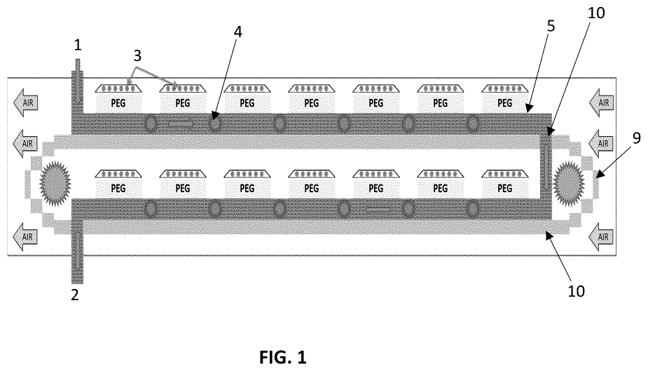

The present disclosure focuses on a drying system (100) for agricultural produce (5), includes heat emitting sources (3) for heating agricultural produce (5), which are placed over a continuous moving grain bed with uniform thickness and with a consistent Produce to Emitter Gap (PEG), so that the heat imparted are uniform over the agricultural produce (5) at any given passage point. FIG. 1 depicts the general arrangement of a heat emitting source for grain drying setup. The system (100) comprises conveyor belts (9), having one or more pass (10) and each of the pass (10) is adapted to transit the agricultural produce. The system (100) further comprises heat emitting sources (3) placed above each pass (10) of the conveyor belt (9), and the heat emitting source (3) radiate heat onto the agricultural produce. The heat emitting sources (3) are a series of Infrared heaters (IR Heaters), which are strategically placed at uniform height over a flowing bed of agricultural produce (5) with controlled thickness to have a preset Produce to Emitter Gap (PEG). The heat emitting sources (3) are charged in a controlled way to emit a pre-determined intensity of radiation or a pre-determined temperature setting to be imparted on the agricultural produce (5).

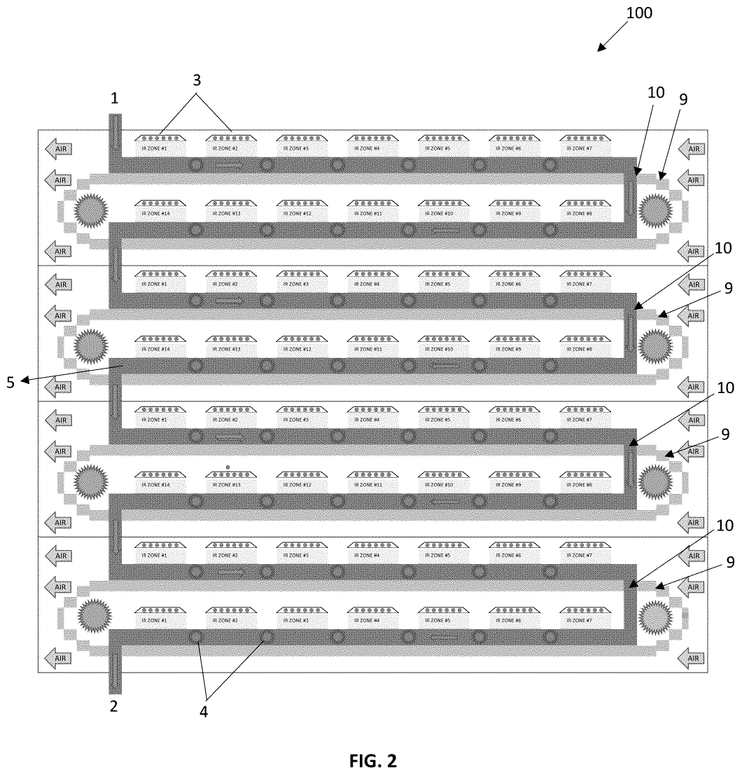

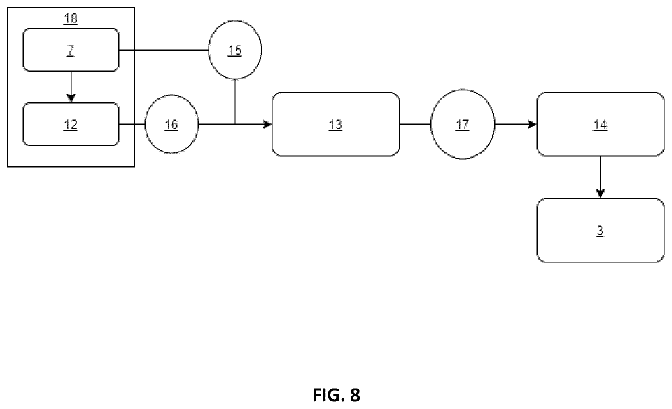

In one embodiment, the passes (10) of the conveyor belts (9) are divided into multiple heat zones (18), as shown in FIG. 2. This helps to control the heating process by controlling each of the heat zones (18). The control of these heat zones (18) can be manually carried by changing intensity or temperature of the heating sources of each of these zones. However, in another embodiment, to automate the whole process, the drying system shall be provided with various sensors, microprocessors, and heat controller which cooperates together to automate the heating process according predefined rules. In such scenario, each heat zone (18) shall have at least one or more temperature sensors which generates a temperature data (15) for it, or one or more moisture sensors which generates the moisture data (16) for each heat zone (18), or combination thereof. The microprocessor processes at least one of the temperature data (15) for each heat zones (18), the moisture data (16) of each of the heat zones (18), or combination thereof. Based, on such processing, the microprocessor generates change triggers (17) of each of the heat zones (18), and the heat controller is adapted to receive and process each of the change triggers (17) and further control the one or more heat emitting source based on such processing. The continuous grain bed thus moves under a series of horizontally positioned heat emitting sources (3) placed above the grain bed, which are imparting radiant heat energy on a controlled basis at a preset value to emulate the theoretical drying curve suitable for that particular produce to be dried. This system (100) assures that the amount of energy transfer to the agricultural produce (5) is regulated precisely, controlled with capability to perform to a preset gradient curve along the grain flow path. This automation process is further described through FIG. 8, where only one heat zone (18) is shown to be controller, for explanation purpose. FIG. 8 shows a section of one of the passes which has a temperature sensor (7) and a moisture sensor (12). The temperature sensor (7) generates the temperature data (15) for the heat zone (18), and the moisture sensor (12) generate the moisture data (16) for the heat zone (18). The microprocessor (13) processes the temperature data (15) and the moisture data (16) and generates a change trigger (17) for the heat emitting source. The heat controller (14) receives and processes the change trigger (17), and controls the heat emitting source (3) based on such processing.

FIG. 2 represents the overall concept of the Heat emitting source (3) emulating the theoretical drying curve of the agricultural produce (5) by providing different levels of radiant heat energies onto the agricultural produce (5) as it passes below these heaters (3) along its flow path. A set of heaters function as one zonal unit and maintains the radiant energy value to a preset Wattage/Sq·m. or target temperatures as is preferred by the user using sensors, relays and control circuits and in fully automated mode. Thus, each radiant heat zone (18) needs to perform to one preset value only using the sensor-based feedback control arrangement due to the dynamic nature of the agricultural produce (5) due to the continuous flow process to emulate a larger drying curve performance across the entire drying cycle.

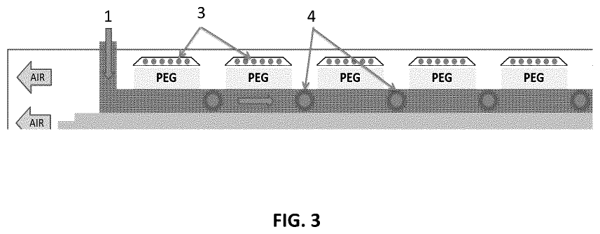

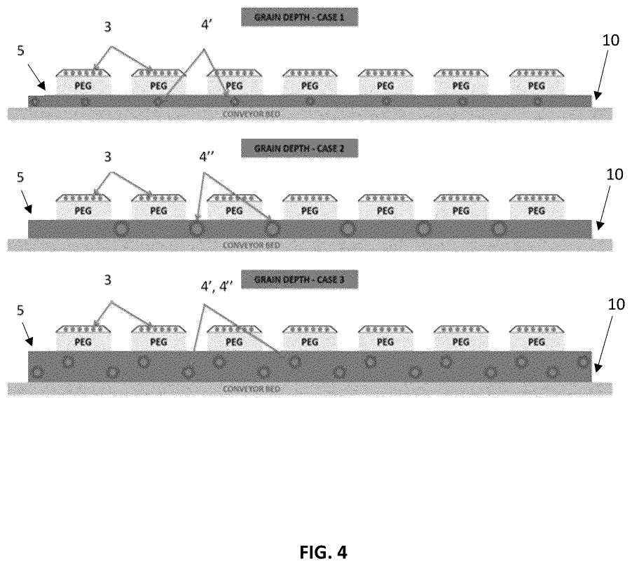

FIG. 3 shows a section of the drying system (100) of another exemplary embodiment. A series of mixing means (4) are shown to be placed at a predefined depth along the grain flow path. These mixers will ensure adequate mixing of the grain to help achieve a uniform heating across various depths. In another embodiment, as shown in FIG. 4, these mixing means (4) are provided at various heights to give a thorough mix across depths. In FIG. 4, three different cases of placement of mixing means (4) are provided. In case 1, a first mixing means (4′) are provided which are placed at a first predefined height, and in case 2, a second mixing means (4″) are provided which are placed at a second predefined height. While in case 3, both the first mixing means (4′), and the second mixing means (4″) are shown to be placed at the first predefined height and the second predefined height respectively. It is also pertinent to be noted, that the first mixing means (4′) and the second mixing means (4″) are placed at different positions onto the path at predefined intervals. This kind of arrangement further enhances the mixing capabilities of the agricultural produce. A typical heat penetration depth for a medium wavelength IR heat is about 30 mm. If the grain bed thickness is higher than this penetration limit, like 125 mm or more can be evenly heated still using this continuous flow IR heat drying method by using this series of mixing means (4′, 4″) along the grain flow path.

The cases provided in FIG. 4 ensures that various types of mixing means (4′, 4″) could be employed to suit a variety of grain bed heights in this IR heating process to ensure sufficient and thorough mixing of the agricultural produce (5) to achieve a consistent heating of the agricultural produce (5) across the entire depth of the grain bed. The mixing means (4) are placed at predefined intervals along the pass (10) of the conveyor belt (9). The mixing means (4) can be static or rotatable. In case of static mixing means they are presented as rods which run across width of the conveyor belt/pass, and the bed of the agricultural produce passes through such static mixers/rods, the agricultural produce gets displaced to change their position on the bed. In case, when the mixing means (4) are rotatable, they further enhance displacement of the produce on the bed, by rotating the produce on the bed while the produce is on the bed. The rotatable mixers are also enabled to work when the conveyor belt is not moving the produce. This specifically help when for certain malfunctioning the conveyor belt is not moving, and to save quality of the agricultural produce, the produce needs to be rotated to avoid any overheating. In another embodiment, the mixing means (4) may be shakers, which when shook can mix efficiently. In yet another embodiment, the mixing means (4) may be based on any working principle so as to perform efficient mixing.

The depth of penetration of the IR radiation, for e.g. the medium wavelength type suitable for grain heating will have a limited depth of penetration typically around 30 mm. In order for the system (100) to be able to handle a sizeable production volume of agricultural produce (5) for drying purpose, using IR radiation with medium wavelength, the system needs to maintain a much thicker agricultural produce bed sizes like 100 mm to 200 mm. In such cases, it is needed that the agricultural produce bed must have a lengthier pass (10) with grain mixing along the way.

The mixing means (4) put to use at varied depths and at multiple locations of the pass (10), ensures a thorough mixing of the agricultural produce (5) for an eventual uniformity in grain temperatures. This mixing is crucial to this set up as it is needed to have the heating of the agricultural produce (5) uniform across agricultural produce (5) being processed for higher volume requirements. As already mentioned, these mixing means (4) can be of varied designs, static or rotating as the need would be. In case of more depth, it could be seen that more heat emitting sources (3) are deployed to have more wattage/sq. m radiant density and more mixing means (4) deployed across various depth of the bed to have a heightened degree of grain mixing for uniform grain heating.

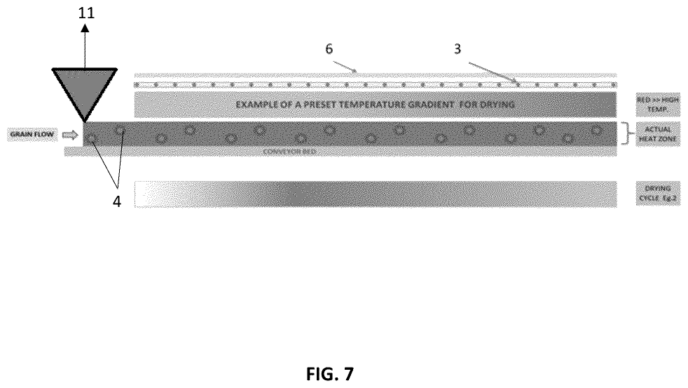

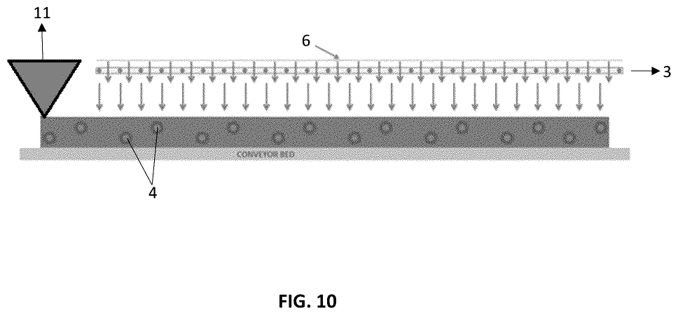

The heat emitting sources (3) are further provided with radiation reflectors (6), which reflects the radiations towards the pass (10). In FIG. 7, the radiation reflectors (6) are placed above the heat emitting source (3). However, in an alternate embodiment, the radiation reflectors can be above the heat emitting sources (3), or onto one of sides non-parallel to a surface of the conveyor belt (9), or combination thereof. FIG. 10 depicts the use of Radiation reflectors (6) arrangement that could be deployed to enhance the energy efficiency of the IR heating process with redirecting of the outward radiations on to the grain bed. This is a standard practice of use of Radiation reflectors (6) along with heat emitting sources (3) which is also shown here. This is a standard practice to use the Radiation reflectors (6) along with heat emitting sources (3) which will greatly improve the efficiency of heat transfer on to the agricultural produce (5) by approx. 50%.

FIG. 1 also shows presence of the air movement which move above or around the agricultural produce, while it is in transit. The air movement is facilitated through aeration means which is provided between passes (10) of the conveyor belts (9). It is important to provide aeration during IR drying to help the moisture vapors from the agricultural produce (5) to escape into the atmosphere in order to achieve effective drying. However, in an alternate embodiment, such aeration means need not be provided, and any other alternate means for removing vapor moistures can be provided. It is pertinent to be noted that these aeration means can be simply windows or openings provided to an enclosure in which the system is placed which facilitates intake of air, and further ventilate it out. The complete aeration or ventilation process can be enhanced by using pumping mechanism or fans or exhaust.

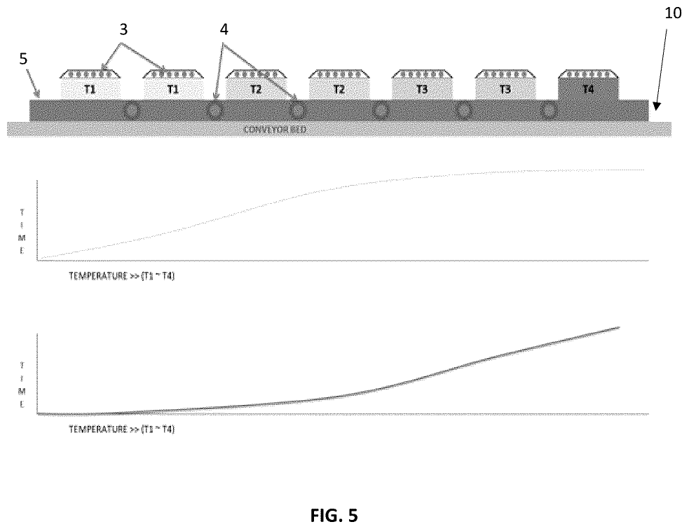

FIG. 5 depicts the various drying cycles that could be deployed under IR/Radiation heating arrangements to suit different produces and volumes simply by setting the radiant energy densities to be imparted on the grain bed along the grain flow paths for the intended heating levels of the agricultural produce (5). With an automated programmable closed loop control system, any drying cycle can be thus achieved and operated upon the agricultural produce (5) with a high level of precision suitable to meet the specific requirement depending on the type, volumes and moisture levels of the produce etc.

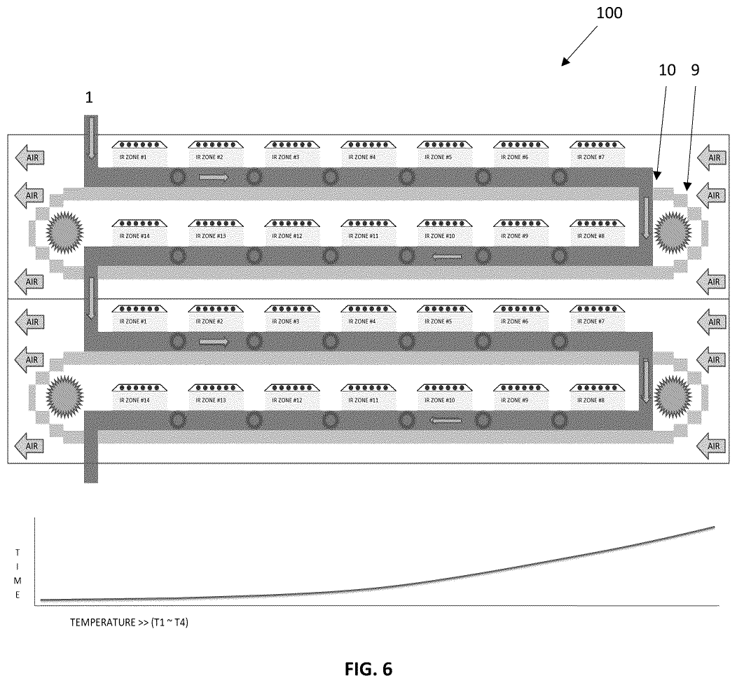

FIG. 6 depicts a multi-pass grain flow process with the IR heating arrangement. In this type of process design it is possible to emulate any theoretical cycle in a smooth and precise way by designing the related process parameters in terms of total travel length/travel time of grain in its entire flow cycle on the conveyor with relevant conveyor speed settings, adequate grain mixing and appropriate grain bed thickness settings with a matching radiant energy impartment on the agricultural produce (5).

FIG. 7 depicts a visual representation for clear understanding of the various temperature gradients that could be set to act on the agricultural produce (5) as it flows below the series of heat emitting sources (3) to meet the various drying cycle/curve requirements of the end user applications to dry any type of grain in the same dryer system setup. The heat emitting source (3) setup is capable of applying any gradient heating pattern to act on the agricultural produce bed in a continuous flow pattern. This represents a unique capability of the heat emitting sources (3) to perform in accordance to any preset drying curve intended for that particular type of produce as needed by the end user.

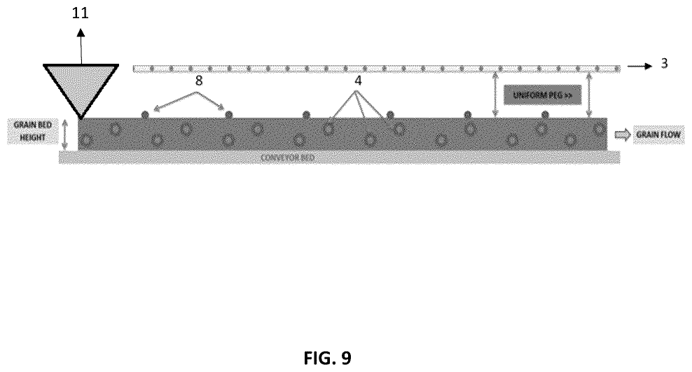

FIG. 9 shows the use of leveler rods (8) to have a level grain surface of the flowing agricultural produce (5) as it flows below the heat emitting sources (3) placed horizontally above. These leveler rods (8) when deployed adequately would remove any surface waviness or imperfections in order to provide a consistent level surface for the consistent PEG requirement for the optimum quality performance of the heat emitting sources (3). It can be seen here that the leveler rods (8) are placed at the top of the intended grain bed height to be achieved which will even out any surface waviness and other imperfections in a continuous flowing grain bed giving a consistent PEG. This is required to provide a height of the agricultural produce bed onto the conveyor belt (9) so as to achieve the predefined gap from the heat emitting source (3). Further, intermittently placed Leveler rods (8) are provided at the intended grain bed height levels along the length of the grain flow path to have a level grain bed surface for a consistent PEG. The leveler rods (8) are used for inflow leveling of the agricultural produce (5) on sustainable basis. However, for the entry level grain bed height control, a hopper (11) is positioned over the conveyor bed at the intended height which will result in the achievement of the desired grain bed of the grain at the start of the grain flow itself.

The major advantage of the present disclosure is that it is based on a clean energy source when used in electric based heat emitting sources (3) and doesn't need the highly polluting contemporary method of fossil fuel, husk-based burning and steam generation or hot air pump methods. It is understood that a standard 100 T drying currently consumes about 15 T of husk burning while this process can completely avoid this carbon foot print on a sustained basis.

A single rice mill unit with a daily capacity of 100 T which when deploys this IR heat based drier system would effectively eliminate 3500 T of husk burning in one year. This is a green initiative potential invention with a massive scope of carbon reduction globally. The global rice production in 2019 was nearly 500 Million Metric Tonnes.

### EQUIVALENTS

The embodiments herein and the various features and advantageous details thereof are explained with reference to the non-limiting embodiments in the description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

Throughout this specification, the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles and the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

While considerable emphasis has been placed herein on the particular features of this disclosure, it will be appreciated that various modifications can be made, and that many changes can be made in the preferred embodiments without departing from the principles of the disclosure. These and other modifications in the nature of the disclosure or the preferred embodiments will be apparent to those skilled in the art from the disclosure herein, whereby it is to be distinctly understood that the foregoing descriptive matter is to be interpreted merely as illustrative of the disclosure and not as a limitation.

### LIST OF REFERRAL NUMERALS

100—System for drying agricultural produce
1—Grain in
2—Grain out
3—Heat emitting sources
4—Mixing means
5—Grains
6—Radiation reflectors
7—Temperature Sensor
8—Leveler rods
9—Conveyor Belt
10—Pass
11—Hopper
12—Moisture Sensor
13—Microprocessor
14—Heat controller
15—Temperature data
16—Moisture data
17—Trigger
18—Heat zone

1. A system (100) for drying agricultural produce comprising:
one or more conveyor belt (9) having one or more pass (10) and each of the pass (10) is adapted to transit the agricultural produce (5);
one or more heat emitting source (3) placed above each pass (10) of the conveyor belt (9), and the heat emitting source (3) is adapted to radiate heat onto the agricultural produce (5); and
a PEG gap maintenance means (8,11) adapted to maintain a predefined gap between the agricultural produce (5) and the heat emitting source (3).

2. The system (100) according to the claim 1 comprising:
a heat controller (14) adapted to control the one or more heat emitting source (3) by either controlling intensity of the radiation or temperature of the heat emitting source (3).

3. The system (100) according to the claim 2 comprising:
one or more temperature sensors (7), or one or more moisture sensors (12), or combination thereof, the temperature sensors (7) are adapted to sense at least a temperature of the agricultural produce (5) or the heat controller (14) or combination thereof, and adapted to generate a temperature data (15), and the moisture sensors (12) are adapted to sense at least moisture of the agricultural produce or an environment in which is agricultural produce is to be transited or in transit, or combination thereof, and adapted to generate a moisture data (16);
a microprocessor (13) adapted to receive and process at least the temperature data (15), the moisture data (16), or combination thereof, along with a predefined set of rules, and to generate a change trigger (17),
wherein the heat controller (14) is adapted to receive and process the change trigger (17) and adapted to control the one or more heat emitting source (3) based on such processing.

4. The system (100) according to the claim 3, wherein the one or more passes (10) of the one or more conveyor belts (9) are divided into more than one heat zones (18), and each heat zones (18) have at least one or more temperature sensors (7) to generate the temperature data (15) for each heat zone (18), or one or more moisture sensors (12) to generate the moisture data (16) for each heat zone (18), or combination thereof, and the microprocessor (13) is adapted to process at least one of the temperature data (15) of each heat zones (18), the moisture data (16) of each of the heat zones (18), or combination thereof, to generate change triggers (17) of each of the heat zones (18), and the heat controller (14) is adapted to receive and process each of the change triggers (17) and adapted to control the one or more heat emitting source based on such processing.

5. The system (100) according to the claims 1 comprising:
one or more mixing means (4) adapted to mix the agricultural produce (5) while the agricultural produce (5) is in transit.

6. The system (100) according to the claim 5, wherein the one or more mixing means (4) are placed along the length of the one or more pass (10) through which the agricultural produce (5) is adapted to be transited, wherein the mixing means (4) are placed at a predefined distance which is more than the predefined gap between the agricultural produce (5) and the heat emitting source (3).

7. The system (100) according to the claim 6 comprising more than one category of mixing means (4′,4″), and each category of the mixing means (4) are placed at different predefined distances. The system (100) according to the claim 6, wherein the mixing means (4) are placed at predefined intervals along the pass (10) of the conveyor belt (9).

9. The system (100) according to the claim 5, wherein the mixing means (4) are rotatable.

10. The system (100) according to the claim 1 comprising:
Radiation reflectors (6) functionally coupled to the heat emitting source (3), and to reflect the radiations towards the pass (10) which is adapted to transit the agricultural produce (5) for drying.

11. The system (100) according to the claim 10, wherein the radiation reflectors (6) are placed either above the heat emitting source (3), or onto one of sides non-parallel to a surface of the conveyor belt (9), or combination thereof.

12. The system (100) according to the claim 1, wherein the PEG gap maintenance means comprises a leveler rod (8) placed at a leveler distance from the Heat emitting source (3) which is equivalent to the predefined gap.

13. The system (100) according to the claim 1, wherein the PEG gap maintenance means comprises a hopper (11) placed on a path of inlet of the agricultural produce (5) to a first pass (10) of the system (100), and is placed at a hop distance from the first pass (10) of the conveyor belt (9), which is required to provide a height of the agricultural produce (5) bed onto the conveyor belt (9) so as to achieve the predefined gap from the heat emitting source (3).

14. The system (100) according to the claim 1 comprising:
an aeration means adapted to pass the air around and/or through the agricultural produce (5) when the agricultural produce (5) is in transit.

15. The system (100) according to the claim 14, wherein an aeration means is provided between passes (10) of the one or more conveyor belts (9).

16. The system (100) according to the claim 1, wherein the heat emitting source (3) works on infrared radiation principles.
